(19) United States
(12) Patent Application Publication
(10) Pub. No.: US 2018/0114109 A1
(43) Pub. Date: Apr. 26, 2018

(54) DEEP CONVOLUTIONAL NEURAL NETWORKS WITH SQUASHED FILTERS

(71) Applicant: Nokia Technologies Oy, Espoo (FI)

(72) Inventor: Yazhao LI, Tianjin (CN)

(21) Appl. No.: 15/299,037

(22) Filed: Oct. 20, 2016

(51) Int. Cl. G06N 3/04; G06N 3/08; G06F 17/11

(52) U.S. Cl. CPC G06N 3/04; G06F 17/11; G06N 3/08

(57) ABSTRACT

In accordance with an example embodiment of the present invention, a method comprising: obtaining a plurality of training cases; initializing a filter corresponding to each convolutional layer in a convolutional neural network, wherein the convolutional neural network comprises at least one convolutional layer; applying a squashing function on the filter; computing convolutions of patches from the plurality of training images and the filter which has applied the squashing function; and obtaining parameters of the squashing function and parameters of the filter based on the computed convolutions.

### TECHNICAL FIELD

The present application relates to machine learning and, in particular, deep convolutional neural network.

### BACKGROUND

Deep Neural Network (DNN) has achieved state-of-the-art performance in the applications of image recognition, object detection, acoustic recognition, and so on. One important instance of DNN is deep Convolutional Neural Network (CNN). Representative applications of CNN include, for example, AlphaGo, Advanced Driver Assistance Systems (ADAS), self-driving car, Optical Character Recognition (OCR), face recognition, large-scale image classification, and Human Machine Interaction (HCI).

Deep CNN is mainly organized in interweaved layers of two types: convolutional layers and pooling (subsampling) layers with one or more convolutional layers followed by a pooling layer. The role of the convolutional layers is feature representation with the semantic level of the features increasing with the depth of the layers. Each convolutional layer consists of a number of feature maps (channels). In the traditional CNN methods, each feature map is obtained by sliding (convoluting) a filter over the input channels with predefined stride followed by a nonlinear activation. In each sliding position, the inner product of the filter and input channels covered by the filter is computed. Then the result of the inner product is transformed by a nonlinear activation function.

### SUMMARY

Various aspects of examples of the invention are set out in the claims.

According to a first aspect of the present invention, a method comprising: obtaining a plurality of training cases; initializing a filter corresponding to each convolutional layer in a convolutional neural network, wherein the convolutional neural network comprises at least one convolutional layer; applying a squashing function on the filter; computing convolutions of patches from the plurality of training images and the filter which has applied the squashing function; and obtaining parameters of the squashing function and parameters of the filter based on the computed convolutions.

According to a second aspect of the present invention, A non-transitory computer storage medium encoded with a computer program, the program comprising instructions that when executed by one or more computers cause the one or more computers to perform operations comprising: obtaining a plurality of training cases; initializing a filter corresponding to each convolutional layer in a convolutional neural network, wherein the convolutional neural network comprises at least one convolutional layer; applying a squashing function on the filter; computing convolutions of patches from the plurality of training images and the filter which has applied the squashing function; and obtaining parameters of the squashing function and parameters of the filter based on the computed convolutions.

According to a third aspect of the present invention, a system comprising: obtaining a plurality of training cases; initializing a filter corresponding to each convolutional layer in a convolutional neural network, wherein the convolutional neural network comprises at least one convolutional layer; applying a squashing function on the filter; computing convolutions of patches from the plurality of training images and the filter which has applied the squashing function; and obtaining parameters of the squashing function and parameters of the filter based on the computed convolutions.

### BRIEF DESCRIPTION OF THE DRAWINGS

For a more complete understanding of example embodiments of the present invention, reference is now made to the following descriptions taken in connection with the accompanying drawings in which:

FIG. 1a and 1b depict example processes for the traditional convolution and the proposed convolution in accordance with some example embodiments;

FIG. 2 depicts an example squashing function in accordance with some example embodiments;

FIG. 3 illustrates an example of convolution in the testing stage in accordance with some example embodiments;

FIG. 4 illustrate an example method of applying regularization and convolution in computing the convolutional layers in accordance with some example embodiments; and

FIG. 5 illustrates an example computing environment for implementing the convolutional neural network techniques in accordance with some example embodiments

### DETAILED DESCRIPTION OF THE DRAWINGS

Deep CNN has a large number of parameters due to its large depth and width. The main parameters are the parameters of the filters used for computing the convolutional layers. On one hand, the large number of parameters make it possible for CNN to have a high capacity to fit relatively complicated decision functions. One the other hand, it requires a very large training set to compute the optimal values of the large number of the parameters of the filters in order to get small test error. However, in practice, the amount of training data is limited. To overcome the problem, various regularization techniques have been proposed to reduce the effective capacity of the CNN so that smaller test error (equally, the smaller generalization error) can be obtained with the limited training data. A common regularization method applied on the filters is to add an L2 norm or L1 norm penalty of the filters into the objective function. The penalty term has a non-negative weight which balances the penalty term and the classification-error related term. This kind of methods belongs to the technique of weight decay and has the following problems:

(1) The weight of the penalty term is empirically chosen as a constant which is not guaranteed to be optimal.

(2) Because of the introducing of the penalty term, the filter is iteratively updated by adding a new term which multiplicatively shrinks the filter by a constant factor. The constant factor is proportional to the weight of the penalty term. Consequently, the constant factor is also not guaranteed to be optimal.

It is the intent of this invention to solve the problems and getting better recognition performance. It is proposed to nonlinearly squash the parameters of the convolutional filters (filters are also called kernels). Because the range of the squashing function is limited, the effects of applying the squashing function on the filters are properly constraining and regularizing the filters. The parameters of the squashing function and the parameters of the filters are jointly learned in a unified framework. Therefore, compared with traditional methods, the proposed regularization method does not have empirical and non-optimal parameters. Because of the unified and optimal regularization and convolution, the proposed method is capable of extracting more expressive and discriminative features and achieving higher recognition rate.

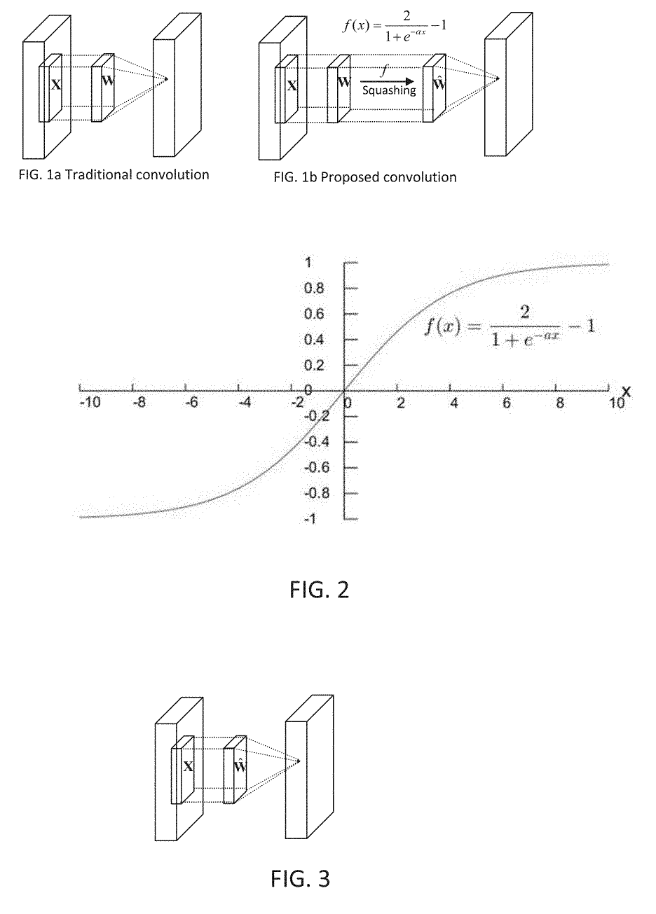

FIG. 1a and 1b depicts example processes for the traditional convolution and the proposed convolution in accordance with some example embodiments.

Let P∈ [symbol] ^{H×W×D} be a patch to be convolved where H×W stands for the spatial size and D stands for the number of channels (feature maps). By vectoring, the three-order tensor P can be reshaped as an H×W×D dimensional column vector X∈ [symbol] ^{(H×W×D)×1}. As can be seen from FIG. 1a, traditional convolution employs a linear filter Wₖ∈ [symbol] ^{(H×W×D)×1} whose size is the same as the patch X . The subscript k indexes the filter. Let K be the number of filters. Specifically, the traditional convolution can be performed by computing the inner product:

cₖ=Wₖ^{T}X∈ [symbol] ¹, k=1,2, . . . , K (1)

where K is the number of output channels. The convolution converts the patch of spatial size H×W into as a scalar cₖ.

Now we describe how the proposed method integrates the convolution and regularization. Let wₖᵢ be the i-th element of the filter Wₖ. As can be seen from FIG. 1b, the proposed method is squashing the elements of the filter by a squashing function ƒ(x;α) where α is the parameter of the function. With the squashing function, wₖᵢ is transformed to ŵₖᵢ

ŵₖᵢ=ƒ(wₖᵢ; α). (2)

We denote the squashed filter as Ŵₖ whose i-th element is Ŵₖᵢ and express the process of computing Ŵₖ from Wₖ as:

Ŵₖ=ƒ(Wₖ;α). (3)

Armed with the squashed filter, the convolution becomes:

cₖ=(ƒ(Wₖ))_{T}X=Ŵₖ^{T}X. (4)

The squashing function has the following properties:
1. It is monotonic increasing.
2. It is absolutely integrable.
3. It is non-linear.
4. Its range is limited.

A possible form of the squashing function is:

$$f ( x ) = \frac{2}{1 + {e}^{- α x}} - 1 , \qquad ( 5 )$$

where the parameter a controls the slope of the function. FIG. 2 visualizes the squashing function in which some example embodiments of the present invention may be practiced. The range of the squashing function is [−1, 1]. Consequently, the value of any element of the filter Ŵₖ is in the range of [−1, 1]. Accordingly, the norm of the filter Ŵₖ is limited, which plays a regularization role of the learning the convolutional neural networks.

Training stage: learning the parameter of the squashing function and the parameters of the filters.

Suppose that the CNN has L layers. The L layers are organized in interweaved layers of two types: convolutional layer and pooling layers with one or more convolutional layers followed by a pooling layer. The filter Wₖ∈ [symbol] ^{(H×W×D)×1} is initialized corresponding to each convolutional layer where H×W stands for the patch size and D stands for the number of channels (feature maps). Denote the patch of previous layer by an H×W×D dimensional column vector X∈ [symbol] ^{(H×W×D)×1}. Compute the convolutional result cₖ by cₖ=(ƒ(Wₖ))^{T}X where the squashing function ƒ is applied on the filter Wₖ.

The parameters of the squashing function and the parameters of the filter are obtained by minimizing the mean squared error of the training set. The standard back-propagation algorithm can be used for solving the minimization problem. In the back-propagation algorithm, the gradients of the mean squared error with respect to the parameters of the filters and parameters of the squashing function are computed and back-propagated. The back-propagation is conducted in several epochs until convergence. Therefore, both the convolution and regularization are optimal and no empirical parameters are required.

If there is a pooling layer after a convolutional layer, then adopt any pooling method to compute the pooling layer. For example, classical max-pooling method may be adopted.

After the parameters of the filters Wₖ are obtained, compute the final filter Wₖ used for testing by Ŵₖ=ƒ(Wₖ).

Testing state: use the learned parameters and the network for testing. Once the parameters are learned, they can be used for classifying an unknown samples, for example, to classify testing images.

Step 1: Compute the convolutional layers by computing the inner product cₖ between a patch X and the filter Ŵₖ^{T}:

cₖ=Ŵₖ^{T}X. (6)

Note that cₖ can also equivalently be obtained by cₖ=(ƒ(Wₖ))^{T}X. But cₖ=Ŵₖ^{T}X is much efficient than cₖ=(ƒ(Wₖ))^{T}X. So it is preferable to adopt cₖ=Ŵₖ^{T}X.

Step 2: If there is a pooling layer after a convolutional layer, then adopt any pooling method to compute the pooling layer. For example, classical max-pooling method can be adopted.

Step 3: Use the result of the final layer as the classification result.

FIG. 3 illustrates an example of convolution in the testing stage in accordance with some example embodiments. It is noted that the squashing function is applied in the training stage and the learned filter Ŵₖ contains the squashing information. Therefore, in the testing stage, squashing is not explicitly conducted. So the computational cost of the proposed convolution is identical to the one of the traditional convolution while our method can yield superiority in regularization and classification.

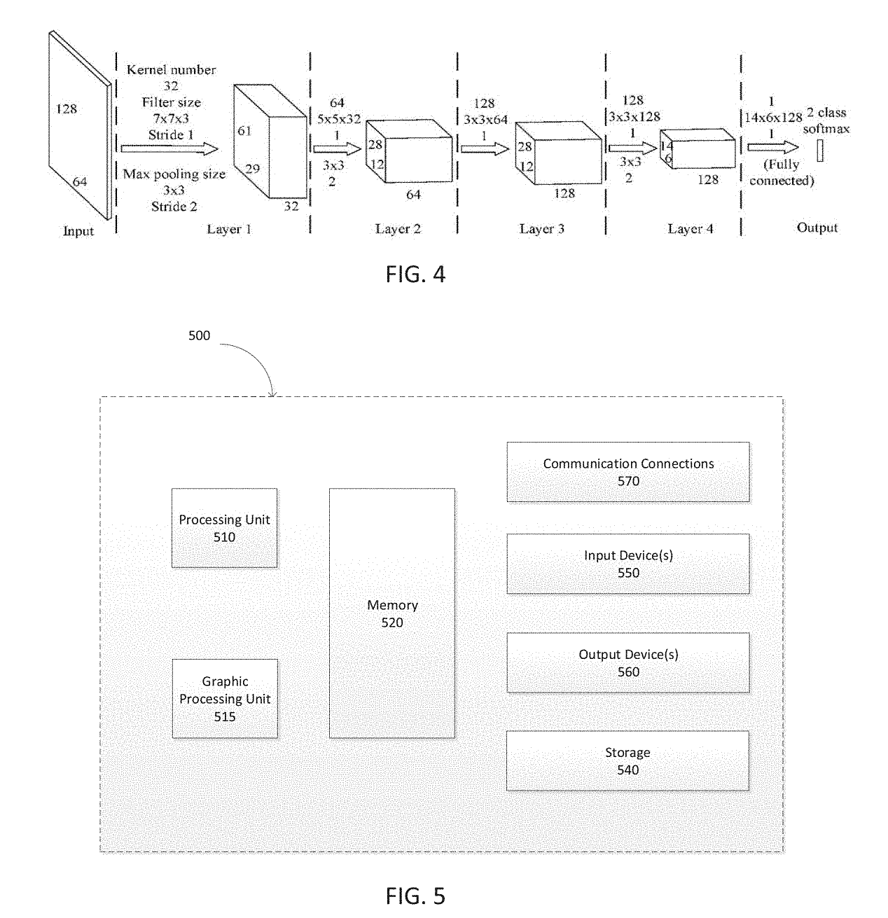

The proposed regularization and convolution may be used in any architecture of CNN by replacing its convolution with the proposed method. FIG. 4 shows an example of CNN where the proposed regularization and convolution are employed in accordance with some example embodiments. In FIG. 4, the CNN consists of four convolutional layers and one fully connected layer. The proposed regularization and convolution are applied in computing the convolutional layers.

The above described neural network training and testing techniques can be performed on any of a variety of devices in which digital media signal processing is performed, including among other examples, computers; image and video recording, transmission and receiving equipment; portable video players; video conferencing; and etc. The techniques can be implemented in hardware circuitry, as well as in digital media processing software executing within a computer or other computing environment, such as shown in FIG. 5.

FIG. 5 illustrates a generalized example of a suitable computing environment (500) in which described embodiments may be implemented. The computing environment (500) is not intended to suggest any limitation as to scope of use or functionality of the invention, as the present invention may be implemented in diverse general-purpose or special-purpose computing environments.

With reference to FIG. 5, the computing environment (500) includes at least one processing unit (510), a GPU (515), and memory (520). The processing unit (510) executes computer-executable instructions and may be a real or a virtual processor. In a multi-processing system, multiple processing units execute computer-executable instructions to increase processing power. The memory (520) may be volatile memory (e.g., registers, cache, RAM), non-volatile memory (e.g., ROM, EEPROM, flash memory, etc.), or some combination of the two. The memory (520) stores software implementing the described convolutional neural network training and testing techniques. The GPU (515) may be integrated with the processing unit 510 on a single board or may be contained separately.

A computing environment may have additional features. For example, the computing environment (500) includes storage (540), one or more input devices (550), one or more output devices (560), and one or more communication connections (570). An interconnection mechanism (not shown) such as a bus, controller, or network interconnects the components of the computing environment (500). Typically, operating system software (not shown) provides an operating environment for other software executing in the computing environment (500), and coordinates activities of the components of the computing environment (500).

The storage (540) may be removable or non-removable, and includes magnetic disks, magnetic tapes or cassettes, CD-ROMs, CD-RWs, DVDs, or any other medium which can be used to store information and which can be accessed within the computing environment (500). The storage (540) stores instructions for implementing the described neural network training and testing techniques.

The input device(s) (550) may be a touch input device such as a keyboard, mouse, pen, or trackball, a voice input device, a scanning device, or another device that provides input to the computing environment (500). For audio, the input device(s) (550) may be a sound card or similar device that accepts audio input in analog or digital form, or a CD-ROM reader that provides audio samples to the computing environment. The output device(s) (560) may be a display, printer, speaker, CD-writer, or another device that provides output from the computing environment (500).

The communication connection(s) (570) enable communication over a communication medium to another computing entity. The communication medium conveys information such as computer-executable instructions, compressed audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The digital media processing techniques herein can be described in the general context of computer-readable media. Computer-readable media are any available media that can be accessed within a computing environment. By way of example, and not limitation, with the computing environment (500), computer-readable media include memory (520), storage (540), communication media, and combinations of any of the above.

Without in any way limiting the scope, interpretation, or application of the claims appearing below, a technical effect of one or more of the example embodiments disclosed herein may include enabling machine learning of deep convolutional neural network.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims. Other embodiments may be within the scope of the following claims.

What is claimed is:

1. A method, comprising:
obtaining a plurality of training cases;
initializing a filter corresponding to each convolutional layer in a convolutional neural network, wherein the convolutional neural network comprises at least one convolutional layer;
applying a squashing function on the filter;
computing convolutions of patches from the plurality of training images and the filter which has applied the squashing function; and
obtaining parameters of the squashing function and parameters of the filter based on the computed convolutions.

2. The method of claim 1, wherein the squashing function is a sigmoid function.

3. The method of claim 1, wherein the squashing function and parameters of the filter are obtained by minimizing the mean squared error of the training cases.

4. The method of claim 3, wherein minimizing the mean squared error of the training cases is performed through a back propagation algorithm.

5. The method of claim 1, further comprising: applying a classical max-pooling method if a pooling layer exists after convolutional layer.

6. The method of claim 1, further comprising: obtaining a plurality of test cases;
computing the convolutional layers by computing convolution of patches from the plurality of test cases.

7. The method of claim 6, further comprising: applying a classical max-pooling method if a pooling layer exists after convolutional layer.

8. A non-transitory computer storage medium encoded with a computer program, the program comprising instructions that when executed by one or more computers cause the one or more computers to perform operations comprising:
obtaining a plurality of training cases;
initializing a filter corresponding to each convolutional layer in a convolutional neural network, wherein the convolutional neural network comprises at least one convolutional layer;
applying a squashing function on the filter;
computing convolutions of patches from the plurality of training images and the filter which has applied the squashing function; and
obtaining parameters of the squashing function and parameters of the filter based on the computed convolutions.

9. The computer storage medium of claim 8, wherein the squashing function is a sigmoid function.

10. The computer storage medium of claim 8, wherein the squashing function and parameters of the filter are obtained by minimizing the mean squared error of the training cases.

11. The computer storage medium of claim 10, wherein minimizing the mean squared error of the training cases is performed through a back propagation algorithm.

12. The computer storage medium of claim 8, further comprising: applying a classical max-pooling method if a pooling layer exists after convolutional layer.

13. The computer storage medium of claim 8, further comprising: obtaining a plurality of test cases; computing the convolutional layers by computing convolution of patches from the plurality of test cases.

14. The computer storage medium of claim 13, further comprising: applying a classical max-pooling method if a pooling layer exists after convolutional layer.

15. A system comprising one or more computers and one or more storage devices storing instructions that, when executed by the one or more computers, cause the one or more computers to perform operations comprising:
obtaining a plurality of training cases;
initializing a filter corresponding to each convolutional layer in a convolutional neural network, wherein the convolutional neural network comprises at least one convolutional layer;
applying a squashing function on the filter;
computing convolutions of patches from the plurality of training images and the filter which has applied the squashing function; and
obtaining parameters of the squashing function and parameters of the filter based on the computed convolutions.

16. The system of claim 15, wherein the squashing function is a sigmoid function.

17. The system of claim 15, wherein the squashing function and parameters of the filter are obtained by minimizing the mean squared error of the training cases.

18. The system of claim 17, wherein minimizing the mean squared error of the training cases is performed through a back propagation algorithm.

19. The system of claim 15, further comprising: applying a classical max-pooling method if a pooling layer exists after convolutional layer.

20. The system of claim 15, further comprising: obtaining a plurality of test cases;
computing the convolutional layers by computing convolution of patches from the plurality of test cases.
